(19) United States
(12) Patent Application Publication
(10) Pub. No.: US 2013/0093123 A1
(43) Pub. Date: Apr. 18, 2013

(54) CASE FOR ENCLOSING A PERSONAL ELECTRONIC DEVICE MANUFACTURED FROM A POLYURETHANE OR SILICON COMPOUND AND METHOD FOR MAKING SAME

(71) Applicant: Speculative Product Design, LLC, Mountain View, CA (US)

(72) Inventor: Bryan Lee Hynecek, Redwood City, CA (US)

(73) Assignee: Speculative Product Design, LLC, Mountain View, CA (US)

(21) Appl. No.: 13/649,740

(22) Filed: Oct. 11, 2012

Related U.S. Application Data
(60) Provisional application No. 61/547,424, filed on Oct. 14, 2011.

(51) Int. Cl. B29C 35/08

(52) U.S. Cl. CPC B29C 35/0805
USPC 264/496

(57) ABSTRACT

A method for manufacturing a case with a cavity for retaining a personal electronic device is disclosed. The case comprises a thin film outer layer and a soft inner layer. The method employs a transparent mold that allows a reactive compound to be cured in the mold. The thin film outer layer may be preformed and placed in the mold or it may be formed in the mold. The reactive compound is placed within the thin film inner layer and then the top portion of the mold is inserted to form the cavity. Ultraviolet light may be transmitted through the mold and used to cure the reactive compound.

### CROSS-REFERENCE

The present application claims the benefit of U.S. Provisional Application Ser. No. 61/547,424 filed Oct. 14, 2011, which is incorporated herein by reference in its entirety.

### BACKGROUND

1. Field of the Invention

The present disclosure relates generally to protective cases and methods of manufacturing cases for an electronic device and specifically to cases and methods that utilize at least two layers to form the case, a thin film outer layer and a flexible inner layer.

2. Description of the Background

Mobile phones, smart phones, tablet computers, laptops, personal readers, personal electronic assistants, MP3 players as well as other portable electronic devices are widely used and have become a ubiquitous part of every day life. Such devices, although designed to be used in real world environments, often contain sensitive electronics and are subject to damage if dropped from a normal operating position. Despite attempts to design these complicated electronic devices for real world application, it is often necessary to utilize some form of protective case to shield and protect the electronic devices from damage due to drops or falls. Additionally, cases may allow a user to personalize their device by incorporating graphics or other images. Many different types and designs of cases exist and provide a wide range of protections and features. Cases may range from purely decorative to utilitarian, from soft pliable cases, to co-molded soft and hard cases to rigid cases. Soft case tend to provide less protection then rigid cases but are easy to use and easy to install on an electronic device. Rigid cases provide maximum protection, but due to the nature of the rigid materials it is often hard or not possible to insert the electronic device into a case molded from a single piece. Accordingly, most rigid cases often composed of multiple parts such as a front and back or top and bottom which may increase their size and the thickness of the materials used and the overall bulk of the device. They often need to be snapped together and assembled around the device to form a rigid shell for the device. Traditional co-molded cases, having soft and hard layers provide the optimum balance of flexibility and protection, but due to traditional manufacturing techniques, often result in cases with thicker then necessary outer case resulting in cases that add significant bulk to the device. Furthermore, due to limitations of the various manufacturing techniques such as injection molding, the rigid outer layer is often required to be thicker then desirable. It is therefore desirable to have a case that provides protection and flexibility while reducing the thickness and weight of the rigid portion. Embodiments of the present application disclose cases and methods for manufacturing such cases.

### SUMMARY

Cases for enclosing a portable electronic device are herein disclosed. The cases may be one-piece or multiple pieces. Exemplary cases comprise at least two layers; a first flexible inner layer that may be manufactured from a polyurethane or silicon compound, and a second, thin film, exterior layer which may be manufactured from PET polyethylene terephthalate, PC polycarbonate, PP polypropylene, BOPP biaxially oriented polypropylene, OPP oriented polypropylene, Styrene, APET amorphous polyester terephthalate, and BoPET biaxially oriented polyethylene terephthalate. Generally, the flexible inner layer and/or the thin film exterior layer may act in concert to protect an enclosed personal electronic device (PED) from damage due to, for example, exposure to dirt contaminants, impact, or shock.

An embodiment of the case may be flexible enough so that it deforms to accommodate the insertion of a portable electronic device and, following insertion, returns to its original shape.

Deformity of the case may be accomplished by any known means including but not limited to materials selected, corner cut outs, structural integrity or design, relief points in the rigid materials, latches or hinges. The case may include a mechanism for securing the electronic device within the case. Such mechanism include but are not limited to clips, latches, straps, extensions, adhesive materials, magnetic materials, frictional forces, detents, overhangs, lips, grooves, interlocking notches, or any other known securing methods.

In an embodiment, a thin film may be used to form the rigid layer and may be thermo formed or vacuum formed. Additionally and/or alternatively, the rigid layer may be shaped and formed using other molding techniques, such as stamping, pressure forming, chemical forming, or press molding. Use of such a process to form the thin film exterior layer allows the exterior layer to be thinner than if manufactured using, for example, traditional injection-molding process.

In an embodiments, the thin film exterior layer provides rigidity to the case without adding significant bulk. In still another embodiment, the thin film exterior layer comprises a pattern or graphic printed upon the thin film exterior layer. The thin film exterior layer may further provide a smooth, non-stick exterior to the case and thereby allow for easy removal of the case from a user's pocket and/or for manufactured finishes that can not be achieved with other non-smooth substances like rubber.

The flexible inner layer may be shaped to enclose a portable electronic device, such as a mobile phone, laptop computer, or tablet computer. In an embodiment, the flexible inner layer may have a back and side surfaces shaped to cover the back and one or more of the side surfaces of an enclosed personal electronic device, respectively.

The thin film exterior layer may be manufactured from any appropriate thin film material such as plastic PET polyethylene terephthalate, PC polycarbonate, PP polypropylene, BOPP biaxially oriented polypropylene, OPP oriented polypropylene, Styrene, APET amorphous polyester terephthalate, and BoPET biaxially oriented polyethylene terephthalate and may be sized and shaped to snugly fit over and substantially cover an outer portion of the flexible inner layer. In an embodiment, the thin film exterior layer may cover the entire back surface and a substantial portion of the side surfaces of the flexible inner layer.

In an embodiments, the thin film exterior layer may be manufactured from a hard plastic so that it contributes to the overall rigidity of the case and protection of the enclosed personal electronic device.

In an embodiments, the case may be manufactured via a casting process. In one embodiment, a method for manufacturing a case with a fitted cavity for a personal electronic device is disclosed. The method includes inserting, in a cavity of a mold, a thin film exterior layer of a case. Placing, within the thin film exterior layer, a reactive compound. Covering the mold, by placing a transparent or semi-transparent cover that is shaped to form the fitted cavity. Curing the reactive compound by exposing the reactive compound to electromagnetic radiation and removing the case from the mold.

In another embodiment the method comprises thermo-forming the thin film exterior layer of the case in the cavity of the mold. In still another embodiment the thin film exterior layer of the case is vacuum-formed in the cavity of the mold. In another embodiment the electromagnetic radiation has a wavelength that falls within the ultraviolet spectrum. In still another embodiment the reactive compound is Polyurethane or silicon.

In another embodiment the thin film exterior layer has a finished surface and an unfinished surface, and the thin film exterior layer is inserted in the cavity of the mold so that the case has the finished surface on an outside surface of the case. In still another embodiment the finished surface of the thin film exterior layer comprises a graphic or an image. In still another embodiment the thin film exterior layer is composed of PET polyethylene terephthalate, PC polycarbonate, PP polypropylene, BOPP biaxially oriented polypropylene, OPP oriented polypropylene, Styrene, APET amorphous polyester terephthalate, and BoPET biaxially oriented polyethylene terephthalate.

### BRIEF DESCRIPTION OF THE DRAWINGS

The methods, and devices described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1A-E depict an embodiment of the method of the present disclosure.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, and/or components, have been described at a relatively high-level, without detail, in order to avoid unnecessarily obscuring aspects of the present teachings.

A casting process provides an advantage over an injection molding process because it requires the application of less pressure than a conventional injection molding process when manufacturing a case. Thus, a softer material (e.g., acrylic, acrylonitrile butadiene styrene (ABS), aluminum) may be used when fabricating a mold used to manufacture the case. This can reduce the cost, both financial and temporal, of fabricating the mold.

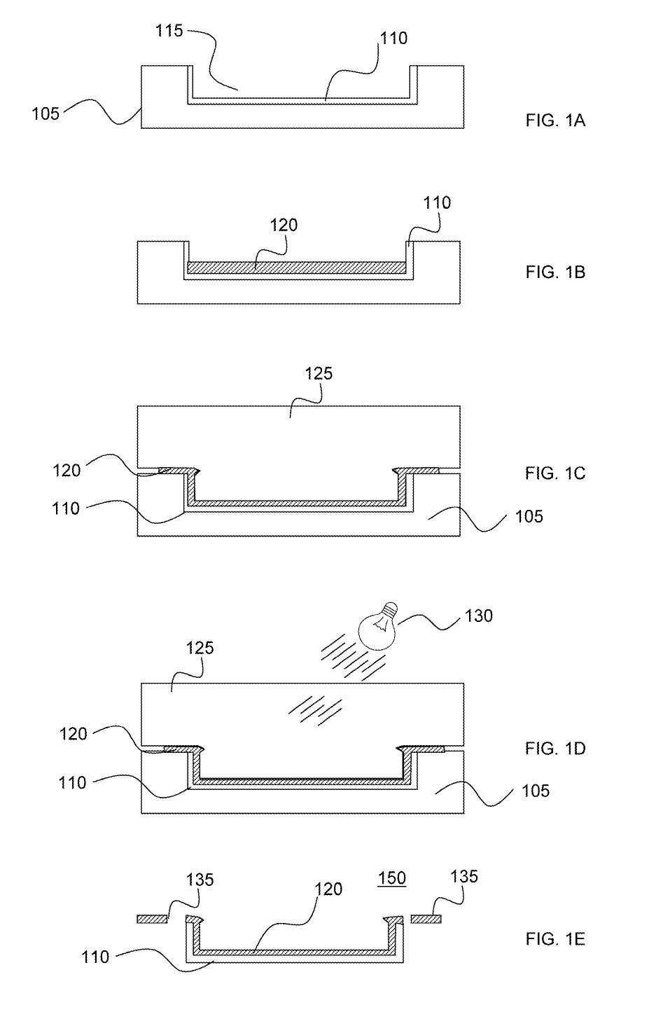

An exemplary casting process for manufacturing an exemplary case in accordance with an embodiment of the present disclosure is herein described. FIG. 1A depicts thin film exterior layer 110 inserted the bottom portion of mold 105, creating a fitted cavity 115. In an embodiment, thin film exterior layer 110 may be formed in place in the bottom portion of mold 105 via, for example, a vacuum or thermo-forming process.

If the thin film exterior layer 110 is to be formed in place, sheet material could be placed over mold 105 and then formed into the thin film exterior layer 110 by vacuum forming, pressure forming, or thermal forming.

Next, as shown in FIG. 1B, a polyurethane, silicon, or other compound 120 may be put into fitted cavity 115 as shown. Compound 120 may be in a liquid or solid state such as a powder, or may be a preformed interim blank in an intermediate state which is placed in fitted cavity 115. If an uncured compound 120 or preformed blank is placed into cavity 115 additional steps may be necessary to cause the compound 120 to flow to fill the mold when top portion 125 of the mold is applied. Various techniques, such as heat, ultra sonic vibration, chemical or pressure may cause compound 120 to flow to fill the form of top portion 125.

Top portion 125 of the mold may be placed on top of the polyurethane or silicon compound 120 as shown in FIG. 1C. Top portion 125 may have various relief cut outs, patterns, or any other feature that needs to be molded or imprinted into the flexible layer of the case. Top portion 125 of the mold may be manufactured from a transparent or semi-transparent material such as glass, plastic, Lexan™ or Polycarbonate to allow for the transmission of heat, light or other forms of electromagnetic radiation. Additionally and/or alternatively, top portion 125 may have a portion that is transparent or semi transparent and a portion that is traditionally manufactured. Similarly, top portion 125 may also have channels or transmission guides incorporated into it to allow transmission of electromagnetic radiation through the top portion 125 to the reactive compound.

Top portion 125 of the mold and underlying compound 120 may then be exposed to electromagnetic radiation such as ultraviolet light, or light of a different frequency, via an electromagnetic radiation source 130. The material used to form top portion 125 must therefore be chosen to ensure that it is suitable for the transmission of the curing energy. In this manner, the underlying compound 120 (polyurethane or silicon) may be cured or hardened into the flexible inner layer of the case as shown in FIG. 1D.

Next, after the casting process is complete and the compound 120 is cured, the rough case 150 may be removed from the bottom portion of the mold 110. The rough case 150, may be trimmed and otherwise cleaned so to remove any excess materials 135 as shown in FIG. 1E. As will be understood, by employing this method, a case comprising a thin film exterior layer with a bonded soft flexible inner layer can be easily manufactured.

Those skilled in the art will recognize that the present teachings are amenable to a variety of modifications and/or enhancements. While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

1. A method for manufacturing a case with a fitted cavity for a personal electronic device, comprising:
inserting, in a cavity of a mold, a thin film exterior layer of a case,
placing, within the thin film exterior layer, a reactive compound;
covering, by placing a transparent or semi-transparent cover that is shaped to form the fitted cavity, the mold;
curing the reactive compound by exposing the reactive compound to electromagnetic radiation; and
removing the case from the mold.

2. The method of claim 1, comprising, thermo-forming the thin film exterior layer of the case in the cavity of the mold.

3. The method of claim 1, comprising, vacuum-forming the thin film exterior layer of the case in the cavity of the mold.

4. The method of claim 1, wherein the electromagnetic radiation has a wavelength that falls within the ultraviolet spectrum.

5. The method of claim 1, wherein the reactive compound is Polyurethane or silicon.

6. The method of claim 1 wherein the thin film exterior layer has a finished surface and an unfinished surface, and
wherein the thin film exterior layer is inserted in the cavity of the mold so that the case has the finished surface on an outside surface of the case.

7. The method of claim 6 wherein the finished surface of the thin film exterior layer comprises a graphic or an image.

8. The method of claim 1 wherein the thin film exterior layer is composed of one of the following:
PET polyethylene terephthalate, PC polycarbonate, PP polypropylene, BOPP biaxially oriented polypropylene, OPP oriented polypropylene, Styrene, APET amorphous polyester terephthalate, and BoPET biaxially oriented polyethylene terephthalate.
